(19) United States
(12) Patent Application Publication
(10) Pub. No.: US 2004/0207643 A1
(43) Pub. Date: Oct. 21, 2004

(54) Attention model enhanced video waveform monitor

(76) Inventors: Bozidar Janko, Portland, OR (US); Kamalesh Patel, Portland, OR (US)

Correspondence Address: TEKTRONIX, INC., Francis I. Gray, MS 50-LAW, P.O. Box 500, Beaverton, OR, 97077, US

(21) Appl. No.: 10/418,405

(22) Filed: Apr. 18, 2003

(51) Int. Cl. G09G 5/00

(52) U.S. Cl. 345/629

(57) ABSTRACT

An attention model enhanced video waveform monitor for identifying and measuring problem areas in a video signal weights the problem areas according to an attentional mapping/masking model. An input video signal is analyzed to produce measurement errors that identify the problem areas. These errors are qualified against a visually masked area and attentional map derived from the video signal. The errors that occur outside the visually masked area within the attentional map are highlighted for an operator on a picture monitor as being significant problem areas for a viewer.

### BACKGROUND OF THE INVENTION

The present invention relates to the analysis of a video signal, and more particularly to an attention model enhanced video waveform monitor that weights areas in the video signal according to a picture area more likely to receive attention by a viewer.

Video waveform monitors and vectorscopes are used to measure and verify that a video signal meets certain requirements, such as being within a given amplitude range, being within bounds of allowable color space, etc. There are well known techniques for displaying the results of these measurements. Some of these techniques include displaying the waveform and vectorscope signals and highlighting areas within the display where allowable limits are exceeded. Other techniques include displaying the video signal on a picture monitor with problem areas highlighted, such as by cross-hatching.

Attention models are means for identifying areas within pictures that are of interest to viewers. They include algorithms to identify areas of motion, object size and various other characteristics of objects—texture, color, skin tones, contrast, etc. The result is an attention map. This is a three-dimensional map depicting areas where viewers are likely to be focused. See for example U.S. Pat. No. 5,940,124 and co-pending U.S. patent application Ser. No. 09/764,726 as well as Improving the Prediction of Picture Quality through Attention Modeling by Wilfried Osberger, Proc. 1999 OSA Annual Meeting, Santa Clara, Calif., Sept. 26-30, 1999.

Visual masking techniques include methods of measuring the extent to which viewers are likely to notice details in pictures, based on spatial and temporal complexity of the areas within the pictures. See for example A Model of Visual Masking for Computer Graphics by James A. Ferwerda et al, SIGGRAPH 97 Conference Proceedings, Annual Conference Series, pgs. 143-152, August 1997.

Currently with conventional waveform monitors and vectorscopes all areas of a picture that have a problem are displayed on a picture monitor, as shown in FIG. 1 by the cross-hatched areas corresponding to problem areas shown on the waveform and diamond gamut displays of FIGS. 2 and 3, without any discrimination as to its significance to a viewer. The significance of problem areas in video signals, such as waveform amplitudes exceeding certain limits, is that picture amplitude and color distortions are likely to occur in these areas. An operator may decide to intervene only in those cases which affect areas where viewers are likely to pay close attention. However these conventional displays do not provide the ability to identify such areas.

What is desired is a technique for determining whether there is a problem area in a video signal based upon its significance to a viewer.

### BRIEF SUMMARY OF THE INVENTION

Accordingly the present invention provides an attention model enhanced video waveform monitor for identifying and measuring problem areas in video and weighting them according to an attentional mapping/masking model. An input video signal is processed to identify measurement errors that indicate problem areas. The errors are qualified against a visually masked and attentional map derived from the video signal. The errors that occur outside the video mask within the attentional map are highlighted for an operator as being significant problem areas to a viewer.

The objects, advantages and other novel features of the present invention are apparent from the following detailed description together in conjunction with the appended claims and attached drawing.

### BRIEF DESCRIPTION OF THE SEVERAL VIEWS OF THE DRAWING

FIG. 1 is a plan view of a picture monitor display showing problem areas in a video signal according to the prior art.

FIG. 2 is a plan view of a conventional waveform monitor display showing problem areas in a video signal which may be shown on the picture monitor display of FIG. 1.

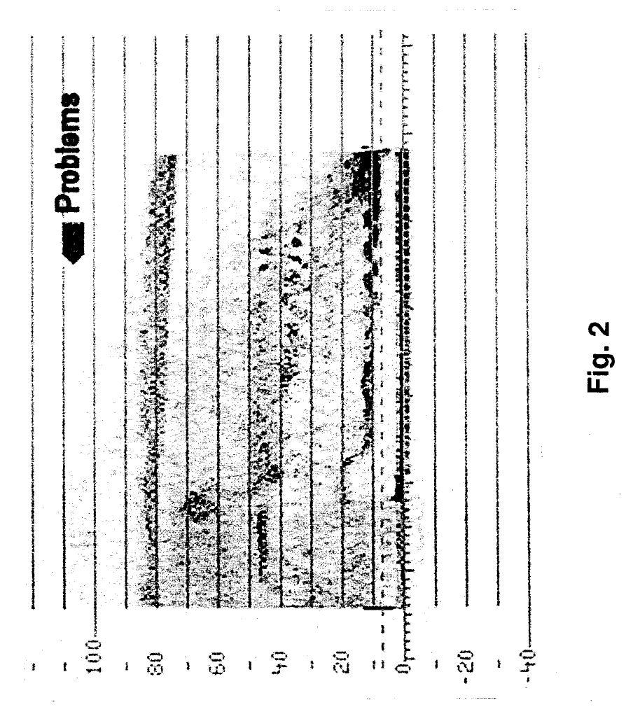

FIG. 3 is a plan view of a conventional diamond gamut display showing problem areas in a video signal which may be shown on the picture monitor display of FIG. 1.

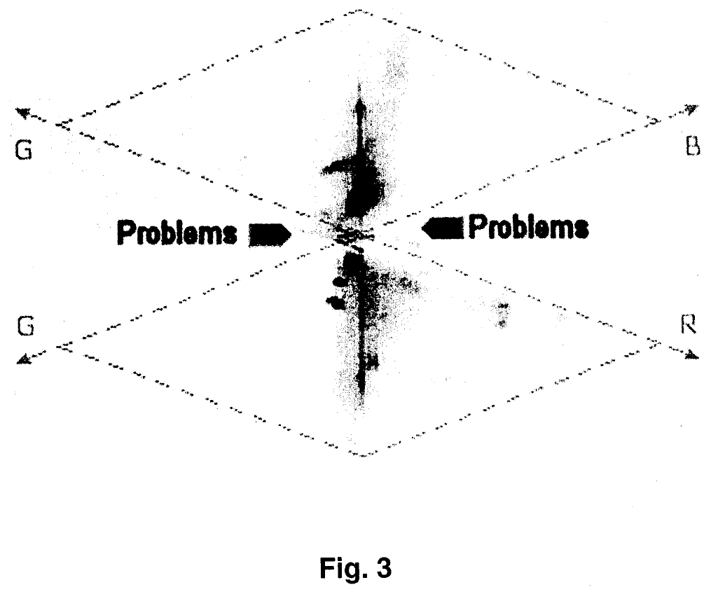

FIG. 4 is block diagram view for an attention model enhanced waveform monitor according to the present invention.

FIG. 5 is a plan view of a picture monitor display showing an attentional map for a video signal according to the present invention.

FIG. 6 is a plan view of a picture monitor display showing a visually masked video according to the present invention.

FIG. 7 is a plan view of a picture monitor display showing an attention model enhanced display of problem areas in a video signal according to the present invention.

### DETAILED DESCRIPTION OF THE INVENTION

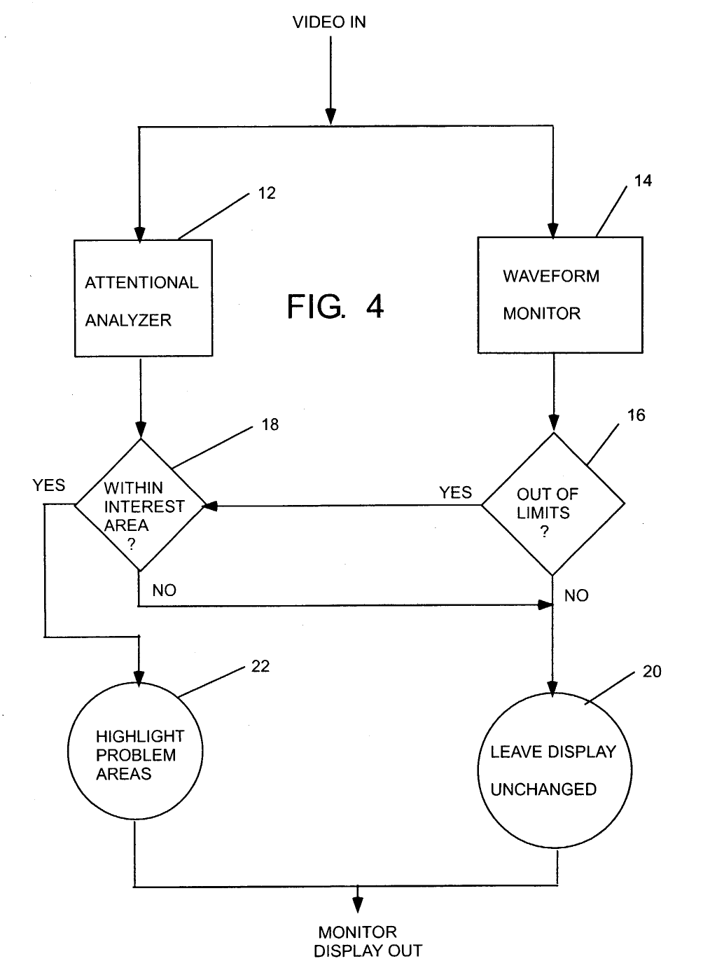

Referring now to FIG. 4 a video signal to be analyzed is input to a conventional video waveform monitor 12 and to a attention model analyzer 14. At a first decision point 16 if the video waveform monitor 12 output indicates that the video signal does not exceed specified limits, then the video signal is passed on unchanged. Otherwise the video signal is passed on to a second decision point 18 to which also is input the output from the attention model analyzer 14. If the exceeded limits identified by the video waveform monitor 12 occur outside areas of interest identified by the attention model analyzer 14, the video signal again is passed on unchanged. However if the identified out-of-limit condition occurs in a viewer significant area, then that portion of the video signal is highlighted on the picture monitor to alert an operator to the condition.

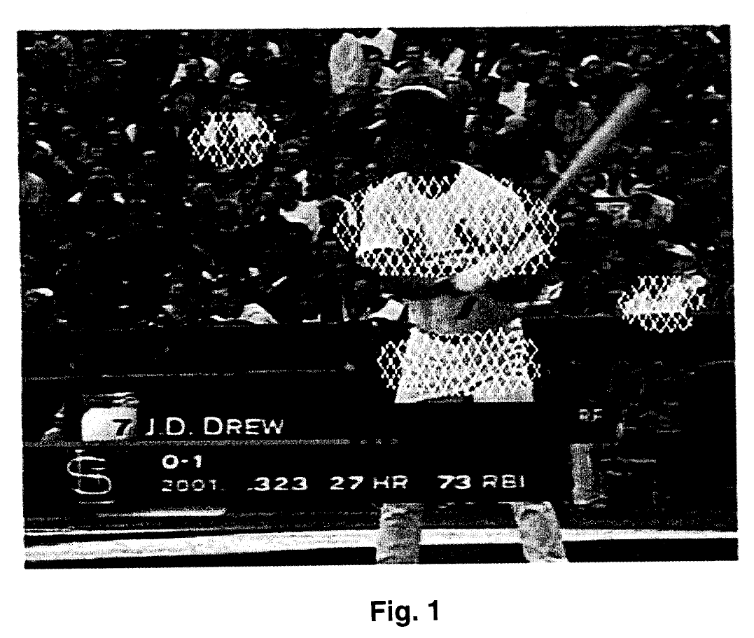

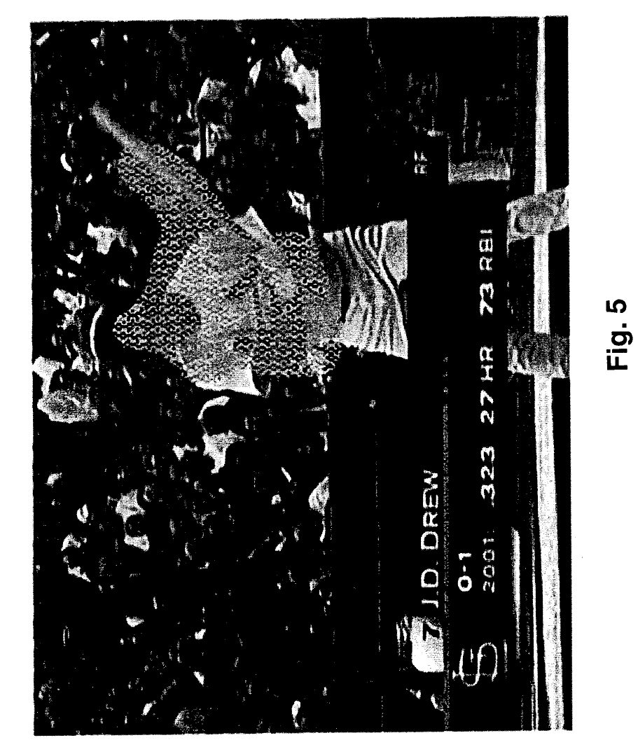

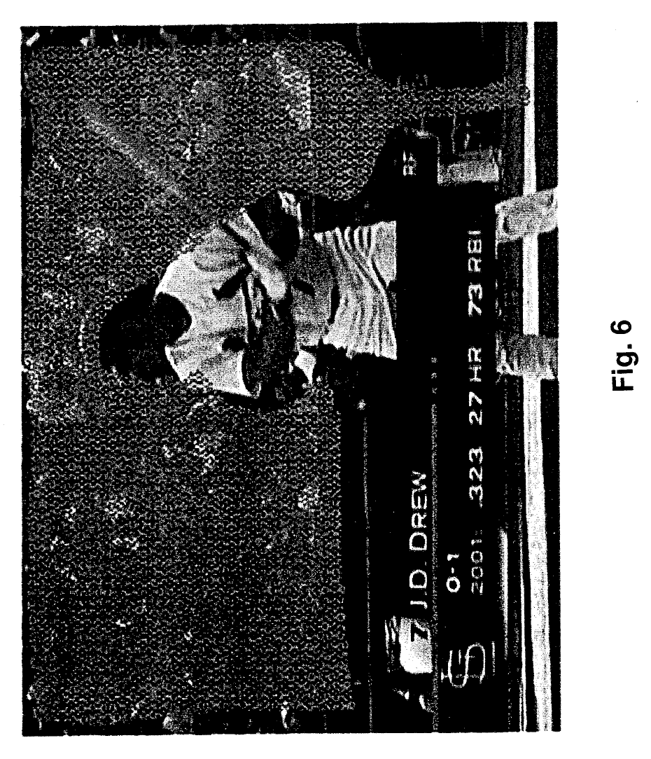

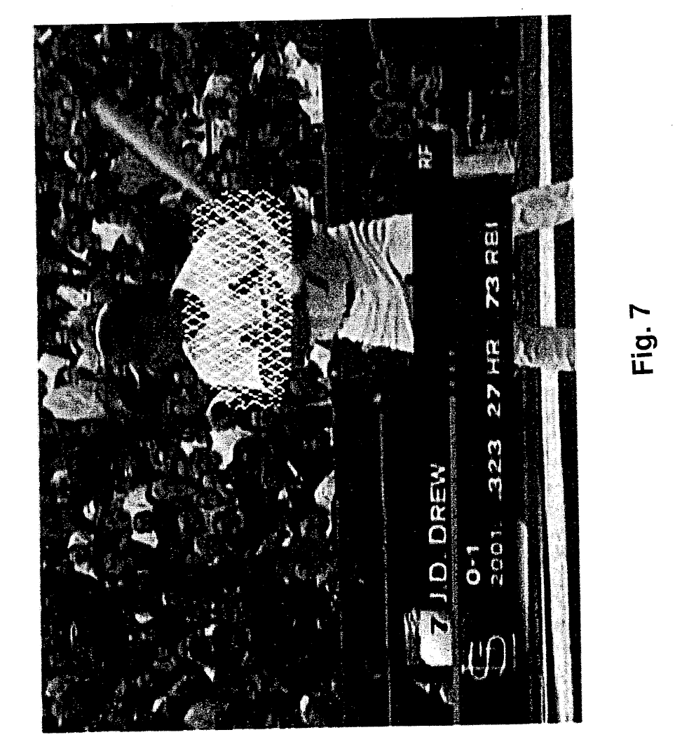

FIG. 5 shows a picture of a baseball batter with an attentional map superimposed, while FIG. 6 shows the same picture with a visually masked area highlighted. FIG. 7 shows the same picture with the background eliminated by visual masking, leaving only the non-overlapping portion of the attentional map within which anomalies appear. Comparing with FIG. 1 the anomalies in the background and below the batter's waist are ignored so only those anomalies in the upper torso area of the batter are highlighted. In other words a viewer's attention is centered on the upper torso of the batter so only anomalies in that area would be significant to a viewer and require correction by an operator.

Thus the present invention provides an improved picture quality analysis by qualifying a video measurement error analysis with an attentional map and video mask so that only those errors detected within the attentional map outside the visually masked area are identified as problem areas on a picture monitor.

1. A method of displaying problem areas in a video signal on a picture monitor based on an attention model comprising the steps of:
analyzing the video signal to determine problem areas;
determining from the video signal according to the attention model an area of viewer significance; and
highlighting the problem areas on the picture monitor that are within the area of viewer significance.

2. The method as recited in claim 1 wherein the determining step comprises the steps of:
generating a visually masked area from the video signal;
generating an attentional map from the video signal; and
combining the visually masked area and attentional map to define the area of viewer significance as a non-overlapping portion of the attentional map.
